(19) United States
(12) Patent Application Publication
(10) Pub. No.: US 2021/0165291 A1
(43) Pub. Date: Jun. 3, 2021

(54) DISPLAY PANEL AND METHOD FOR MANUFACTURING SAME

(71) Applicant: HKC Corporation Limited, Shenzhen City, Guandong (CN)

(72) Inventor: Beizhou HUANG, Shenzhen City, Guangdong (CN)

(21) Appl. No.: 16/068,474

(22) PCT Filed: Jan. 23, 2018
(86) PCT No.: PCT/CN2018/073768

§ 371 Date: Jul. 6, 2018

(30) Foreign Application Priority Data
Sep. 25, 2017 (CN) 201710875554.X

(51) Int. Cl. G02F 1/1362; G02F 1/1368; G02F 1/1339

(52) U.S. Cl. CPC G02F 1/136222; G02F 1/13396; G02F 1/1368; G02F 1/136209

(57) ABSTRACT

This application provides a display panel and a method for manufacturing same, where the display panel includes: a first substrate disposed opposite to a second substrate; a color filter layer formed on one of the first substrate and the second substrate, and a first part and a second part of the color filter layer, where the first part and the second part have different heights; two electrode layers respectively formed on opposite surfaces of the first substrate and the second substrate; the plurality of photo spacers, including a first part disposed opposite to the first spacer and a second part disposed opposite to the second spacer, where a total height of the first spacer and the first part is greater than a total height of the second spacer and the second part.

### BACKGROUND

### Technical Field

This application relates to a manufacturing manner, and in particular, to a display panel and a method for manufacturing same.

### Related Art

With the development of science and technologies, displays with various advantages, such as power saving, zero radiation, a small size, low power consumption, a flat surface and a right angle, a high resolution, stable image quality become more and more popular, especially current various information products, such as smartphones, notebook computers, digital cameras, personal digital assistants (PDA), screens, thereby greatly increasing demand for display panels. Therefore, an operator has to face a problem of how to improve producing process efficiency and a product yield.

A display panel includes two substrates disposed opposite to each other, which may be an active switch array substrate and a color filter substrate, or may be a combination of an array substrate combined with a color filter and an opposite substrate. To ensure stable display quality, a spacer (Photo Spacer) has to be disposed between the two substrates to maintain a fixed gap between the two substrates.

To improve a pressing tolerance of the display panel to an external force, as known to all, a spacer has another design, that is, a spacer with double segment gaps. That is, the spacer is divided into a main spacer (main PS) and a sub spacer (sub PS). Generally the main spacer has a supporting function and the sub spacer is suspended. When the display panel is pressed, the sub spacer has the supporting function. There are mainly two implementations: (1) Film layer stacking: a segment gap between the main spacer and the sub spacer is implemented by raising an active switch array disposed opposite to the main spacer. Therefore, the segment gap between the main spacer and the sub spacer is a total thickness of a metal layer (M2), a semiconductor doping layer (N+), and a semiconductor layer (a-Si). In this design, the spacer is easily interfered by a stacking part, resulting in that a substrate cannot restore from an offset. (2) The segment gap is formed when the main spacer and the sub spacer are produced. However, when this design is used in a liquid crystal display panel, the segment gap between the main spacer and the sub spacer is too small, resulting in that a liquid crystal margin (LC margin) of the liquid crystal display panel is relatively small and a benefit of mass production is relatively low.

### SUMMARY

To resolve the foregoing technical problem, an objective of this application is to provide a display panel and a method for manufacturing same, thereby increasing a segment gap between a main spacer and a sub spacer of the display panel without largely changing an existing production process.

The objective of this application is achieved and the technical problem of this application is resolved by using the following technical solutions. This application provides a display panel, where the display panel comprises: a first substrate, where a plurality of active switches is formed on the first substrate; a second substrate, disposed opposite to the first substrate, where the second substrate comprises a plurality of pixel areas, and the plurality of pixel areas of the second substrate and a plurality of pixel areas of the first substrate correspond to each other; two electrode layers, respectively formed on opposite surfaces of the first substrate and the second substrate; a color filter layer, formed on one of the first substrate and the second substrate; and a plurality of photo spacers, located between the first substrate and the second substrate, where the plurality of photo spacers comprises a first spacer and a second spacer; the color filter layer comprises a first part disposed opposite to the first spacer and a second part disposed opposite to the second spacer; a height of the first part is different from a height of the second part; and a total height of the first spacer and the first part is greater than a total height of the second spacer and the second part.

The technical problem of this application may be further resolved by taking the following technical measures.

In an embodiment of this application, the first substrate is an active switch array substrate. The color filter layer is formed on the second substrate. The first part and the second part are disposed opposite to the active switches of the first substrate. The first spacer is formed between the first part and the active switches of the first substrate, and the second spacer is formed on the second part and is disposed opposite to the active switches of the first substrate.

In an embodiment of this application, the color filter layer comprises a plurality of color resist layers, and the first spacer and the second spacer are disposed on the plurality of color resist layers that is the same, different, or partly the same.

In an embodiment of this application, the plurality of color resist layers comprises three different colors: a red color resist layer, a blue color resist layer, and a green color resist layer, or the plurality of color resist layers comprises four different colors: a red color resist layer, a blue color resist layer, a green color resist layer, and a white color resist layer.

In an embodiment of this application, the first substrate is the active switch array substrate. The color filter layer is formed on the first substrate. The second substrate comprises a light shield layer. The first part and the second part are disposed opposite to the light shield layer. The first spacer is formed between the first part and the light shield layer and the second spacer is formed on the light shield layer and is disposed opposite to the second part.

In an embodiment of this application, the first part is a protruding shape.

In an embodiment of this application, the second part is a concave shape.

A secondary objective of this application is to provide a display panel, comprising: a first substrate, where a plurality of active switches is formed on the first substrate; a second substrate, disposed opposite to the first substrate; a color filter layer, formed on one of the first substrate and the second substrate; two electrode layers, respectively formed on opposite surfaces of the first substrate and the second substrate; and a plurality of photo spacers, located between the first substrate and the second substrate, where the plurality of photo spacers comprises a first spacer and a second spacer; the color filter layer comprises a first part disposed opposite to the first spacer and a second part disposed opposite to the second spacer; the first part and the second part of the color filter layer are uneven surfaces; a height of the first part is greater than a height of the second part; and a total height of the first spacer and the first part is greater than a total height of the second spacer and the second part.

Another objective of this application is to provide a method for manufacturing a display panel, comprising: providing a first substrate and a second substrate disposed opposite to each other; forming active switches on the first substrate; forming a color filter layer on one of the first substrate and the second substrate, where the color filter layer comprises a first part and a second part, and a height of the first part is different from a height of the second part; forming two electrode layers on opposite surfaces of the first substrate and the second substrate; and forming a plurality of photo spacers between the first substrate and the second substrate, where the plurality of photo spacers comprises a first spacer disposed opposite to the first part and a second spacer disposed opposite to the second part; and a total height of the first spacer and the first part is greater than a total height of the second spacer and the second part.

In an embodiment of this application, the first substrate is an active switch array substrate. The color filter layer is formed on the second substrate. The first part and the second part are disposed opposite to the active switches of the first substrate. The first spacer is formed between the first part and the active switches of the first substrate, and the second spacer is formed on the second part and is disposed opposite to the active switches of the first substrate.

In an embodiment of this application, the color filter layer comprises a plurality of color resist layers, and the first spacer and the second spacer are disposed on the plurality of color resist layers that is the same, different, or partly the same.

In an embodiment of this application, the plurality of color resist layers comprises three different colors: a red color resist layer, a blue color resist layer, and a green color resist layer, or the plurality of color resist layers comprises four different colors: a red color resist layer, a blue color resist layer, a green color resist layer, and a white color resist layer.

In an embodiment of this application, the first substrate is the active switch array substrate. The color filter layer is formed on the first substrate. The second substrate comprises a light shield layer. The first part and the second part are disposed opposite to the light shield layer. The first spacer is formed between the first part and the light shield layer and the second spacer is formed on the light shield layer and is disposed opposite to the second part.

In an embodiment of this application, the first part is a protruding shape.

In an embodiment of this application, the second part is a concave shape.

This application can increase a segment gap between a main spacer and a sub spacer of the display panel by using a surface height difference of a color resist and a height difference between spacers without largely changing an existing production process. The segment gap between spacers does not need to stack different film layers, thereby reducing situations in which a substrate cannot restore from an offset because the spacers are interfered by a stacking part. Moreover, during application to a liquid crystal display panel, an obvious height segment gap between the main spacer and the sub spacer can desirably enhance a liquid crystal margin of a liquid crystal display panel and improve a yield of mass production.

### BRIEF DESCRIPTION OF THE DRAWINGS

FIG. 1a is an exemplary schematic cross-section view of a display panel;

FIG. 1b is an exemplary schematic cross-section view of manufacturing a display panel;

FIG. 1c is an exemplary simple configuration diagram of a first-type spacer segment gap of a display panel;

FIG. 1d is an exemplary simple configuration diagram of a second-type spacer segment gap of a display panel;

FIG. 2 is a schematic cross-section view in which a protruding structure of a color resist layer is applied to a display panel shown according to a method of this application;

FIG. 3 is a schematic cross-section view in which a concave structure of a color resist layer is applied to a display panel shown according to a method of this application;

FIG. 4 is a schematic cross-section view in which a protruding structure of a color resist layer is applied to an array substrate shown according to a method of this application;

FIG. 5 is a schematic cross-section view in which a concave structure of a color resist layer is applied to an array substrate shown according to a method of this application;

FIG. 6 is a schematic cross-section view in which a protruding structure of a color resist layer and a stacking film layer are combined to form a composite raising structure shown according to a method of this application;

FIG. 7 is a schematic cross-section view in which a concave structure of a color resist layer and a stacking film layer are combined to form a composite raising structure shown according to a method of this application; and

FIG. 8 is a schematic architectural diagram of a display apparatus of an embodiment shown according to a method of this application.

### DETAILED DESCRIPTION

The following embodiments are described with reference to the accompanying drawings, used to exemplify specific implementable embodiments of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical measures and functions used in the this application to achieve the predetermined invention objectives, specific implementations, structures, features, and functions of a display panel and a method for manufacturing same that are provided in this application are described in detail below with reference to the accompanying drawings and specific embodiments.

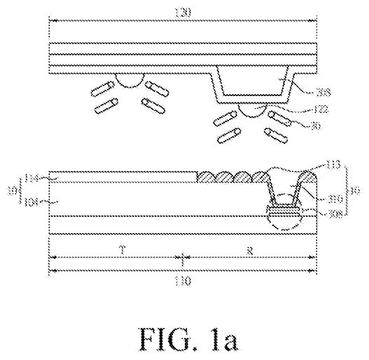

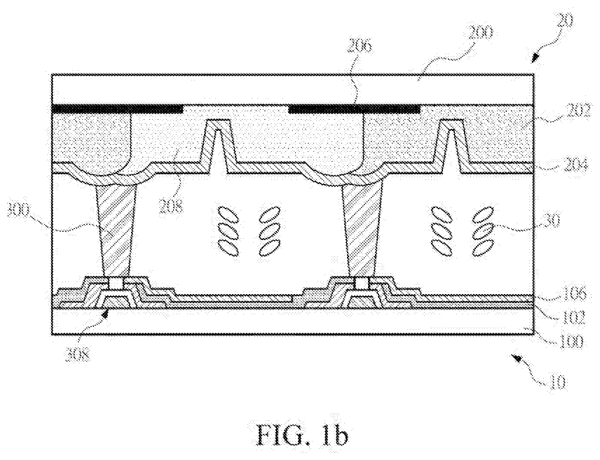

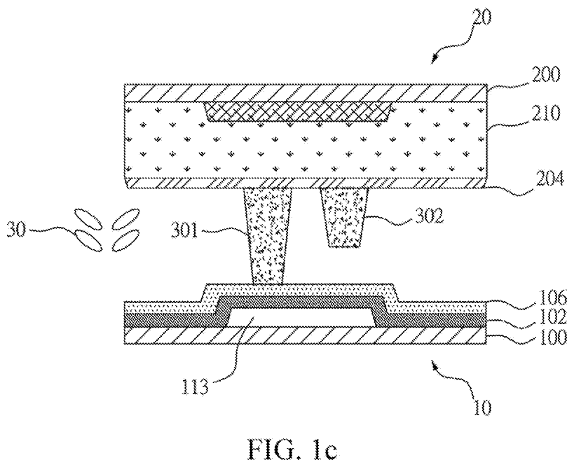

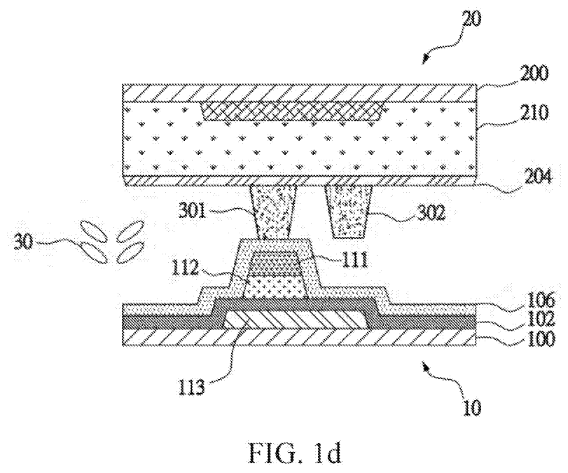

FIG. 1a is an exemplary schematic cross-section view of a display panel. FIG. 1b is an exemplary schematic cross-section view of manufacturing a display panel. FIG. 1c is an exemplary simple configuration diagram of a first-type spacer segment gap of a display panel. FIG. 1d is an exemplary simple configuration diagram of a second-type spacer segment gap of a display panel. Referring to FIG. 1a and FIG. 1b, take a dual-gap and transflective multi-domain vertical alignment (MVA) liquid crystal display as an example. Generally, a dual-gap and transflective liquid crystal display may dispose an adjustment layer 208 in a reflective region R. As shown in FIG. 1a, the adjustment layer may be disposed at a side of a color filter substrate or a side of a thin film transistor substrate. As shown in FIG. 1a, a basic structure of the dual-gap and transflective MVA liquid crystal display includes a first substrate 10, a second substrate 20, and a liquid crystal layer 30. The first substrate 10 includes a plurality of pixel areas 110, and every pixel area 110 includes a reflective region R and a penetration region T. The second substrate 20 includes a color filter layer 210 including color resist layers 202. A plurality of pixel areas 120 is also included on the second substrate 20. The pixel areas 120 and the plurality of pixel areas 110 of the first substrate correspond to each other. Every pixel area 120 has an adjustment layer 208 disposed in a position corresponding to the reflective region R. The liquid crystal layer 30 is disposed between the first substrate 10 and the second substrate 20.

Further referring to FIG. 1a, FIG. 1b, and FIG. 1c, every pixel area 110 of the first substrate 10 includes an active array switch (take a thin film transistor as an example, but this is not limited thereto) and a storage capacitor 308 disposed below the reflective region R. Next, form a planarization layer 104 on an upper surface of the first substrate 10. Then produce an uneven surface on the planarization layer 104 in the reflective region R, and a metal (for example, aluminum, silver, and so on) of high reflectivity is plated as a reflective electrode. In addition, the penetration region T of every pixel area 110 includes a transparent electrode 114. It is worth mentioning that the reflective region R of every pixel area 110 of the first substrate 10 further includes a contact hole 310, used to electrically connect to the reflective electrode and the storage capacitor 308. Moreover, an alignment protrusion (PR for short) 122 is disposed at a position that is on the color filter layer 210 and that is opposite to the reflective region R and the penetration region T of the first substrate 10. The alignment protrusion 122 may change a distribution of an electric line, so that a liquid crystal molecule may tilt toward the alignment protrusion 122 to generate an effect of multi-domains liquid crystal alignment, thereby implementing a wide viewing angle technology and improving a gray scale inversion problem existing in single-domain liquid crystal alignment. As shown in FIG. 1b, generally, when assembling the first substrate 10 and the second substrate 20, the color filter layer 210 further includes a photo spacer (PS for short) 300 to fix a cell gap between panels and a plurality of platforms corresponding to the photo spacer 300 are designed at a side of the first substrate 10, so that the photo spacer 300 can maintain panels to fix the cell gap between panels more steadily.

To improve a pressing tolerance of a display panel, an intermediate substance is designed to be a spacer with double segment gaps. A first type, as shown in FIG. 1c, is that the photo spacer 300 is designed to be a main spacer 301 and a sub spacer 302, and there is a segment gap when the main spacer 301 and the sub spacer 302 are formed. Generally, the main spacer 301 has a supporting function and the sub spacer 302 is suspended. When the display panel is pressed, the sub spacer 302 has the supporting function.

A second type, as shown in FIG. 1d, is that the segment gap between the main spacer 301 and the sub spacer 302 is generally implemented by raising an active switch array disposed opposite to the main spacer 301. Therefore, the segment gap between the main spacer 301 and the sub spacer 302 is an active switch, and has a total thickness of structures such as a metal layer (M2) 111, a semiconductor doping layer (N+) 112, and a semiconductor layer (a-Si) 113.

As described above, although a reflective wide viewing angle display panel is described as an example, an application scope of this application is not limited thereto. This application may further be applied to a dual-gap and transflective display panel and a single-gap and transflective display panel.

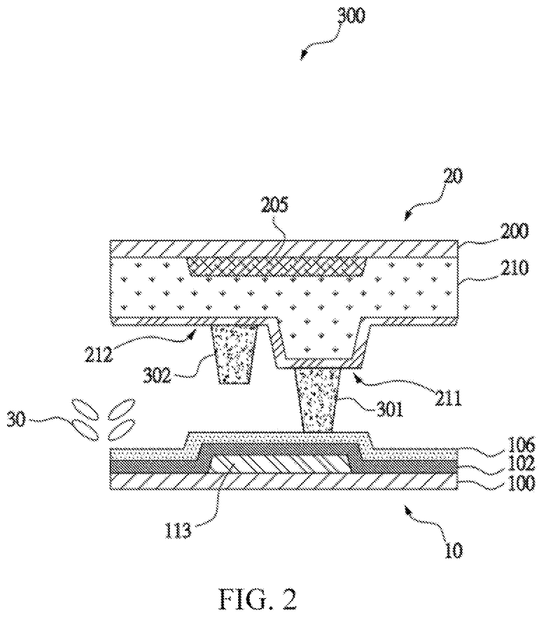

FIG. 2 is a schematic cross-section view in which a protruding structure of a color resist layer is applied to a display panel shown according to a method of this application. Referring to FIG. 2, in an embodiment of this application, a display panel 300 includes a first substrate 10, where a plurality of active switches is formed on the first substrate 10. The first substrate 10 includes: a first base 100, a first insulation layer 102 formed on the first base 100, and a first electrode 106 formed on the first insulation layer 102. A second substrate 20 is disposed opposite to the first substrate 10. The second substrate 20 includes a plurality of pixel areas, where the plurality of pixel areas of the second substrate 20 and a plurality of pixel areas of the first substrate 10 correspond to each other. A color filter layer 210 includes a plurality of color resist layers and is formed on one of the first substrate 10 and the second substrate 20. A plurality of photo spacers is located between the first substrate 10 and the second substrate 20.

The plurality of photo spacers includes a first spacer 301 and a second spacer 302. The color filter layer 210 includes a first part 211 and a second part 212, where the first part 211 is disposed opposite to the first spacer 301 and the second part 212 is disposed opposite to the second spacer 302. A height of the first part 211 is different from a height of the second part 212, and a total height of the first spacer 301 and the first part 211 is greater than a total height of the second spacer 302 and the second part 212, thereby forming a relatively obvious segment gap.

In some embodiments, the first substrate 10 is an active switch array substrate. The second substrate 20 includes: a second base 200, a color filter layer 210 disposed on the second base 200, and a second electrode 204 disposed on the color filter layer 210. The first part 211 and the second part 212 are disposed opposite to the active switches of the first substrate 10. The first spacer 301 is formed between the first part 211 and the active switches of the first substrate 10. The second spacer 302 is formed on the second part 212 and is disposed opposite to the active switches of the first substrate 10.

In some embodiments, the color filter layer 210 includes a plurality of color resist layers, where the plurality of color resist layers includes three different colors: a red color resist layer, a blue color resist layer, and a green color resist layer, or the plurality of color resist layers includes four different colors: a red color resist layer, a blue color resist layer, a green color resist layer, and a white color resist layer. However, this is not limited thereto. The first spacer 301 and the second spacer 302 are disposed on the plurality of color resist layers that is the same, different, or partly the same.

In some embodiments, a height of the first part 211 is greater than a height of the second part 212.

In some embodiments, the first part 211 is a protruding shape.

In some embodiments, the second substrate 20 further includes a light shield layer (for example, a black matrix, BM) 205 that is approximately disposed right above the photo spacer.

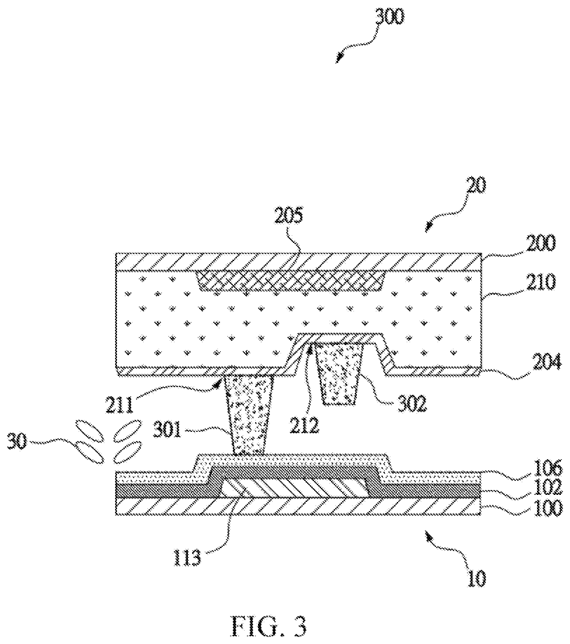

FIG. 3 is a schematic cross-section view in which a concave structure of a color resist layer is applied to a display panel shown according to a method of this application. In some embodiments, different from what is shown in FIG. 2, the second part 212 is a concave shape.

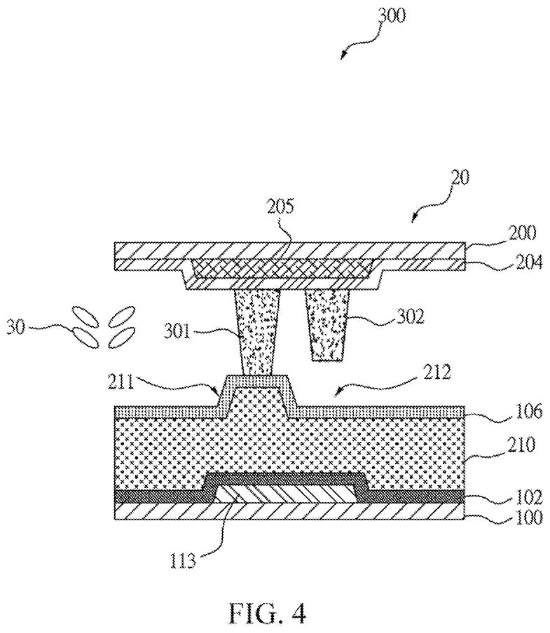

FIG. 4 is a schematic cross-section view in which a protruding structure of a color resist layer is applied to an array substrate shown according to a method of this application. In some embodiments, the first substrate 10 is an active switch array substrate. The color filter layer 210 is formed on the first substrate 10. The second substrate 20 includes a light shield layer 205. The first part 211 and the second part 212 are disposed opposite to the light shield layer 205. The first spacer 301 is formed between the first part 211 and the light shield layer 205 and the second spacer 302 is formed on the light shield layer 205 and is disposed opposite to the second part 212. In some embodiments, the first part 211 is a protruding shape.

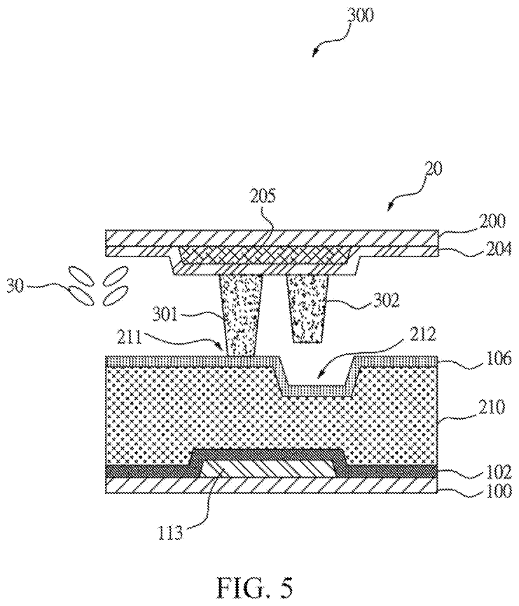

FIG. 5 is a schematic cross-section view in which a protruding structure of a color resist layer is applied to an array substrate shown according to a method of this application. In some embodiments, different from what is shown in FIG. 4, the second part 212 is a concave shape.

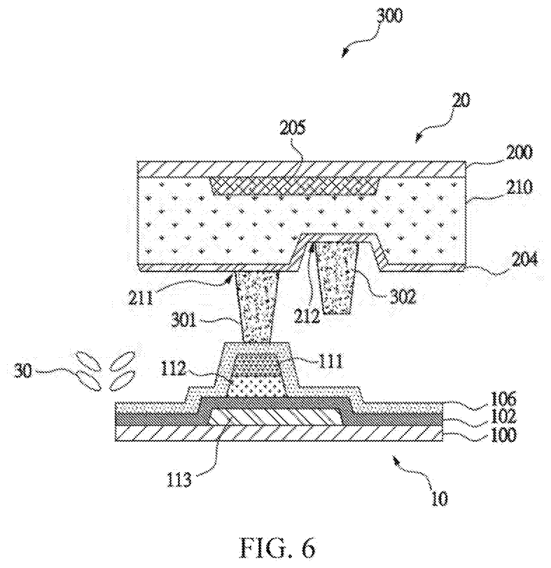

FIG. 6 is a schematic cross-section view in which a protruding structure of a color resist layer and a stacking film layer are combined to form a composite raising structure shown according to a method of this application. In some embodiments, the first substrate 10 is an active switch array substrate. The color filter layer 210 is formed on the second substrate 20. The first part 211 and the second part 212 are disposed opposite to the active switches of the first substrate 10. The first part 211 is a protruding shape. The first spacer 301 is formed between the first part 211 and the active switches of the first substrate 10 and the second spacer 302 is formed on the second part 212 and is disposed opposite to the active switches of the first substrate 10. Therefore, a segment gap between a main spacer 301 a sub spacer 302 is a sum of heights of stacking film layers of the active switches that include structures such as a metal layer (M2) 111, a semiconductor doping layer (N+) 112, and a semiconductor layer (a-Si) 113, and a height difference between the first part 211 and the second part 212.

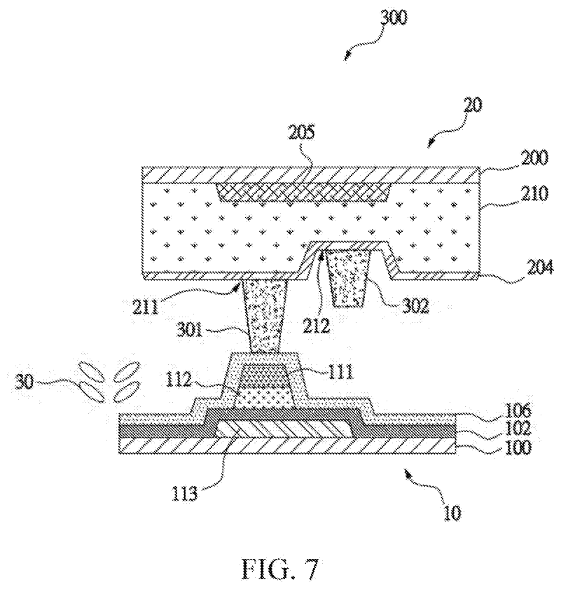

FIG. 7 is a schematic cross-section view in which a concave structure of a color resist layer and a stacking film layer are combined to form a composite raising structure shown according to a method of this application. In some embodiments, different from what is shown in FIG. 6, the second part 212 is a concave shape.

In an embodiment of this application, a method for manufacturing a display panel of this application includes: providing a first substrate 10 and a second substrate 20 disposed opposite to each other; forming a color filter layer 210 on one of the first substrate 10 and the second substrate 20, where the color filter layer 210 includes a first part 211 and a second part 212, and a height of the first part 211 is different from a height of the second part 212; forming two electrode layers (106, 204) on opposite surfaces of the first substrate 10 and the second substrate 20; forming a plurality of photo spacers between the first substrate 10 and the second substrate 20, where the plurality of photo spacers includes a first spacer 301 disposed opposite to the first part 211 and a second spacer 302 disposed opposite to the second part 212; and a total height of the first spacer 301 and the first part 211 is greater than a total height of the second spacer 302 and the second part 212.

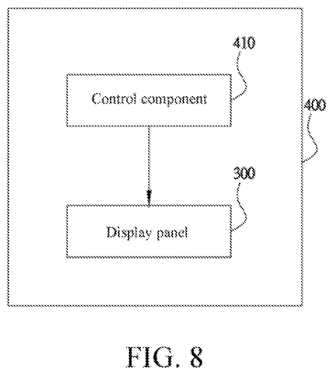

FIG. 8 is a schematic architectural diagram of a display apparatus of an embodiment shown according to a method of this application. In an embodiment of this application, a display apparatus 400 of this application includes a control component 410 and further includes any one of display panels 300 in the forgoing embodiments.

The display panel of this application includes a liquid crystal display panel, including a first substrate 10, a second substrate 20, and a liquid crystal layer 30 formed between the two substrates, where the first substrate 10 and the second substrate 20 may be, for example, an active switch array (mainly a thin film transistor (TFT) in a current process, but this is not limited thereto) substrate or a color filter (CF) substrate. However, this is not limited thereto. In an embodiment, the active switch array and the color filter layer of this application may further be formed on a same substrate.

In some embodiments, the display panel of this application includes a liquid crystal display panel, but is not limited thereto. The display panel may further be an organic light emitting diode (OLED) display panel, a white organic light emitting diode (W-OLED) display panel, a quantum dot light emitting diode (QLED) display panel, a plasma display panel, a curved-face display panel or other types of display panels.

This application can increase a segment gap between a main spacer and a sub spacer of the display panel by using a surface height difference of a color resist and a height difference between spacers without largely changing an existing production process. The segment gap between spacers does not need to stack different film layers, thereby reducing situations in which a substrate cannot restore from an offset because the spacers are interfered by a stacking part. Moreover, during application to a liquid crystal display panel, an obvious height segment gap between the main spacer and the sub spacer can desirably enhance a liquid crystal margin of a liquid crystal display panel and improve a yield of mass production.

The wordings such as “in some embodiments” and “in various embodiments” are repeatedly used. They usually do not refer to a same embodiment; but they may refer to a same embodiment. The words, such as “comprise”, “have”, and “include”, are synonyms, unless other meanings are indicated in the context thereof.

The foregoing descriptions are merely specific embodiments of this application, and are not intended to limit this application in any form. Although this application has been disclosed above through the specific embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A display panel, comprising:
a first substrate, wherein a plurality of active switches is formed on the first substrate;
a second substrate, disposed opposite to the first substrate;
a color filter layer, formed on one of the first substrate and the second substrate;
two electrode layers, respectively formed on opposite surfaces of the first substrate and the second substrate; and
a plurality of photo spacers, located between the first substrate and the second substrate, wherein
the plurality of photo spacers comprises a first spacer and a second spacer; the color filter layer comprises a first part disposed opposite to the first spacer and a second part disposed opposite to the second spacer; a height of the first part is different from a height of the second part; and a total height of the first spacer and the first part is greater than a total height of the second spacer and the second part.

2. The display panel according to claim 1, wherein the color filter layer is formed on the second substrate; the first part and the second part are disposed opposite to the active switches of the first substrate; the first spacer is formed between the first part and the active switches of the first substrate; and the second spacer is formed on the second part and is disposed opposite to the active switches of the first substrate.

3. The display panel according to claim 2, wherein the color filter layer comprises a plurality of color resist layers, and the first spacer and the second spacer are disposed on the plurality of color resist layers that is the same, different, or partly the same.

4. The display panel according to claim 3, wherein the plurality of color resist layers comprises three different colors: a red color resist layer, a blue color resist layer, and a green color resist layer.

5. The display panel according to claim 3, wherein the plurality of color resist layers comprises four different colors: a red color resist layer, a blue color resist layer, a green color resist layer, and a white color resist layer.

6. The display panel according to claim 1, wherein the color filter layer is formed on the first substrate; the second substrate comprises a light shield layer; and the first part and the second part are disposed opposite to the light shield layer.

7. The display panel according to claim 6, wherein the first spacer is formed between the first part and the light shield layer.

8. The display panel according to claim 6, wherein the second spacer is formed on the light shield layer and is disposed opposite to the second part.

9. The display panel according to claim 1, wherein the first part is a protruding shape.

10. The display panel according to claim 1, wherein the second part is a concave shape.

11. A display panel, comprising:
a first substrate, wherein a plurality of active switches is formed on the first substrate;
a second substrate, disposed opposite to the first substrate;
a color filter layer, formed on one of the first substrate and the second substrate;
two electrode layers, respectively formed on opposite surfaces of the first substrate and the second substrate; and
a plurality of photo spacers, located between the first substrate and the second substrate, wherein
the plurality of photo spacers comprises a first spacer and a second spacer; the color filter layer comprises a first part disposed opposite to the first spacer and a second part disposed opposite to the second spacer; the first part and the second part of the color filter layer are uneven surfaces; a height of the first part is greater than a height of the second part; and a total height of the first spacer and the first part is greater than a total height of the second spacer and the second part.

12. A method for manufacturing a display panel, comprising:
providing a first substrate and a second substrate disposed opposite to each other;
forming active switches on the first substrate;
forming a color filter layer on one of the first substrate and the second substrate, wherein the color filter layer comprises a first part and a second part, and a height of the first part is different from a height of the second part;
forming two electrode layers on opposite surfaces of the first substrate and the second substrate; and
forming a plurality of photo spacers between the first substrate and the second substrate, wherein the plurality of photo spacers comprises a first spacer disposed opposite to the first part and a second spacer disposed opposite to the second part; and a total height of the first spacer and the first part is greater than a total height of the second spacer and the second part, wherein
the color filter layer is formed on the second substrate; the first part and the second part are disposed opposite to the active switches of the first substrate; the first spacer is formed between the first part and the active switches of the first substrate; and the second spacer is formed on the second part and is disposed opposite to the active switches of the first substrate.

13. The method for manufacturing a display panel according to claim 12, wherein the color filter layer comprises a plurality of color resist layers, and the first spacer and the second spacer are disposed on the plurality of color resist layers that is the same, different, or partly the same.

14. The method for manufacturing a display panel according to claim 13, wherein the plurality of color resist layers comprises three different colors: a red color resist layer, a blue color resist layer, and a green color resist layer.

15. The method for manufacturing a display panel according to claim 13, wherein the plurality of color resist layers comprises four different colors: a red color resist layer, a blue color resist layer, a green color resist layer, and a white color resist layer.

16. The method for manufacturing a display panel according to claim 12, wherein the color filter layer is formed on the first substrate; the second substrate comprises a light shield layer; and the first part and the second part are disposed opposite to the light shield layer.

17. The method for manufacturing a display panel according to claim 16, wherein the first spacer is formed between the first part and the light shield layer.

18. The method for manufacturing a display panel according to claim 16, wherein the second spacer is formed on the light shield layer and is disposed opposite to the second part.

19. The method for manufacturing a display panel according to claim 12, wherein the first part is a protruding shape.

20. The method for manufacturing a display panel according to claim 12, wherein the second part is a concave shape.
